(19) United States
(12) Patent Application Publication
(10) Pub. No.: US 2026/0229936 A1
(43) Pub. Date: Aug. 6, 2026

(54) STATOR COOLING DEVICE

(71) Applicants: Hyundai Motor Company, Seoul (KR); Kia Corporation, Seoul (KR); CHUNG ANG University Industry Academic Cooperation Foundation, Seoul (KR)

(72) Inventors: Kang Min Yu, Hwaseong-Si (KR); Kyoung Bum Kim, Hwaseong-Si (KR); Hyun Jo Pyo, Hwaseong-Si (KR); Hyoung Soon Lee, Seoul (KR); Jeong Hwan Park, Seoul (KR); Jong Hyun Lee, Seoul (KR); Ju Ho Park, Gumi-Si (KR); Seon U Bae, Seoul (KR)

(73) Assignees: Hyundai Motor Company, Seoul (KR); Kia Corporation, Seoul (KR); CHUNG ANG University Industry Academic Cooperation Foundation, Seoul (KR)

(21) Appl. No.: 19/631,772

(22) Filed: Mar. 27, 2026

(30) Foreign Application Priority Data
Feb. 4, 2025 (KR) 10-2025-0042968

(51) Int. Cl. H02K 1/20

(52) U.S. Cl. CPC H02K 1/20

(57) ABSTRACT

A stator cooling device includes a stator plate including a plurality of stator coils, the stator plate being disposed with a main flow path including a connection flow path that extends toward an internal side of the state plate in a radius direction of the state plate. Furthermore, the stator cooling device includes at least one pair of cooling flow paths stacked on the stator plate along an axial direction of the stator plate and having different structures. The pair of cooling flow paths is configured to guide a fluid introduced through the main flow path to the connection flow path disposed adjacent to each of the cooling flow paths.

### CROSS REFERENCE TO RELATED APPLICATION

The present application claims priority to Korean Patent Application No. 10-2025-0042968, filed Apr. 2, 2025, the entire contents of which are incorporated herein for all purposes by this reference.

### BACKGROUND

### Technical Field

The present disclosure relates to a stator cooling device. More particularly, the present disclosure relates to a stator cooling device applying a stator plate having a cooling flow path with a mesh structure, thereby realizing effective cooling of a stator coil.

### Description of the Related Art

Generally, a driving motor is used as a power source of a hybrid vehicle or an electric vehicle, and the driving motor includes a rotor and a stator which is disposed on an external circumference of the rotor and on which a stator coil is wound.

When a current flows to the stator coil and the rotor is rotated, heat is generated in the stator coil or a stator core. Since the stator coil of the driving motor is a passage through which a current directly flows, a lot of heat is generated. Therefore, if a temperature of heat generated in the stator coil or the stator core exceeds a heat resistance temperature, an insulation material is destroyed, and the motor cannot be driven any more.

Therefore, since the driving motor used for driving a vehicle requires a high torque and a high output, the performance of a cooling system is important for driving the driving motor continuously.

To remove heat generated from such a stator coil or a stator core, a technology for cooling a stator by supplying a refrigerant from outside has been applied. Conventionally, a structure in which a channel where a coolant flows is formed and the stator core and the stator coil are indirectly cooled has been applied to the driving motor.

Since the conventional cooling structure as described above is not configured for directly cooling the stator coil or the stator core, there is a problem that cooling efficiency is reduced. Furthermore, a region through which magnetic flux density passes may be blocked by the conventional cooling structure, there is a problem that the electromagnetic performance is reduced.

### SUMMARY

Accordingly, the present disclosure has been made keeping in mind the above problems occurring in the related art, and an objective of the present disclosure is to provide a stator cooling device being configured so that a cooling flow path is applied in a plurality of stator plates disposed so that stator coils are inserted into and disposed in the stator plates and the plurality of stator plates have mesh structures and shapes of the continuously disposed mesh structures are different from each other so that a fluid flow between the mesh structures, being configured for realizing effective cooling of a stator.

According to an aspect of the present disclosure, there is provided a stator cooling device including: a stator plate including a plurality of stator coils, the stator plate being disposed with a main flow path including a connection flow path that extends toward an internal side of the state plate in a radius direction of the state plate; and at least one pair of cooling flow paths stacked on the stator plate along an axial direction of the stator plate and having different structures, wherein the pair of cooling flow paths is configured to guide a fluid introduced through the main flow path to the connection flow path disposed adjacent to each of the cooling flow paths.

Here, at least two cooling flow paths may be continuously stacked on the stator plate.

Furthermore, the cooling flow paths may be connected to the main flow path, may extend toward the stator coils, and may include mesh structures.

The cooling flow paths may be configured so that the pair of cooling flow paths including mesh holes having different sizes is stacked in front and rear directions so that the fluid continuously flows through in the mesh holes.

Furthermore, the cooling flow paths may include a pair of outlets to be connected to the connection flow path disposed adjacent to the cooling flow paths, and the fluid passing through the mesh holes may flow to the connection flow path through the pair of outlets.

Meanwhile, the cooling flow paths may be connected to the main flow path, may extend toward the stator coils, and may include channel structures.

The cooling flow paths may be configured so that the pair of cooling flow paths including flow channels having different heights is stacked in front and rear directions so that the fluid continuously flows through in the flow channels.

Furthermore, the cooling flow paths may include a pair of outlets to be connected to the connection flow path disposed adjacent to the cooling flow paths, and the fluid passing through the flow channels may flow to the connection flow path through the pair of outlets.

Furthermore, the connection flow path may extend so that the connection flow path is connected to the main flow path and is positioned between the stator coils that are positioned adjacent to each other, and may include a “V” shape with an inclination.

Meanwhile, the stator plate may be disposed so that a plurality of stator plates is spaced apart from each other with a predetermined distance and is disposed between a plurality of general stator plates which is disposed along the axial direction of the stator plates and which is disposed so that the stator coils are inserted into and disposed in the general stator plates.

Furthermore, the stator plate may be disposed so that a plurality of stator plates is spaced apart from each other with a predetermined distance and is disposed between a plurality of general stator plates disposed so that the stator coils are inserted into and disposed in the general stator plates, and the cooling flow paths may be disposed so that the cooling flow paths are concentrated on a center portion in an axial direction of a rotor.

Meanwhile, according to another aspect of the present disclosure, there is disposed a stator cooling device including: a stator; and a rotor configured so that the rotor is configured for being rotated with respect to the stator, wherein the stator includes: a stator plate including a plurality of stator coils, the stator plate being disposed with a main flow path including a connection flow path that extends toward the rotor; and at least one pair of cooling flow paths stacked on the stator plate along an axial direction of the stator and having different structures, and wherein the pair of cooling flow paths is configured to guide a fluid introduced through the main flow path to the connection flow path disposed adjacent to each of the cooling flow paths.

In an exemplary embodiment of the present disclosure, in the plurality of stator plates disposed so that the stator coils are inserted into and disposed in the stator plates, the plurality of stator plates in which the cooling flow path is applied is configured so that the cooling flow path including the mesh structure is applied and the shapes of each mesh structure continuously disposed has different shapes so that the fluid flows between the mesh structures, so that there is an effect that effective cooling of the stator including the stator coil is configured for being realized.

Furthermore, in an exemplary embodiment of the present disclosure, the shape of the connection flow path connecting the cooling flow path has inclination so that the fluid smoothly flows, so that there is an effect that supply and discharge of the supplied fluid are effectively performed.

Furthermore, in an exemplary embodiment of the present disclosure, as the center region along the axial direction of the motor has the highest temperature due to heating generally, a relatively large number of stator plates in which the cooling flow path are applied is stacked on the center region, so that there is an effect that the uniformity of the internal temperature of the motor is configured for being increased.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a view exemplarily illustrating a stator plate for a stator cooling device according to an exemplary embodiment of the present disclosure;

FIG. 2 is a cross-sectional view taken along line A-A′ for showing a main flow path and a connection flow path for the stator cooling device according to an exemplary embodiment of the present disclosure;

FIG. 3 is an enlarged view exemplarily illustrating a region A in FIG. 2 for showing the connection flow path for the stator cooling device according to an exemplary embodiment of the present disclosure;

FIG. 4 is an enlarged view exemplarily illustrating a region B in FIG. 2 for showing a cooling flow path for the stator cooling device according to an exemplary embodiment of the present disclosure;

FIG. 5 is a view exemplarily illustrating the cooling flow paths having different shapes for the stator cooling device according to an exemplary embodiment of the present disclosure;

FIG. 6 is a view exemplarily illustrating a stacked state of the cooling flow path for the stator cooling device according to an exemplary embodiment of the present disclosure;

FIG. 7A and FIG. 7B are views exemplarily illustrating a fluid flow in the stacked state of the cooling flow path for the stator cooling device according to an exemplary embodiment of the present disclosure;

FIG. 8 is a view exemplarily illustrating another embodiment of the cooling flow paths for the stator cooling device according to an exemplary embodiment of the present disclosure, the cooling flow paths having different shapes;

FIG. 9A and FIG. 9B are views exemplarily illustrating another embodiment of a fluid flow in the stacked state of the cooling flow path for the stator cooling device according to an exemplary embodiment of the present disclosure; and

FIG. 10 is a view exemplarily illustrating another embodiment for showing an arrangement of the stator plate for the stator cooling device according to an exemplary embodiment of the present disclosure.

### DETAILED DESCRIPTION

Hereinafter, an exemplary embodiment of the present disclosure will be described in detail with reference to the accompanying drawings.

Advantages and features of the present disclosure, and methods of achieving the advantages and the features, will be apparent from the accompanying drawings and from embodiments that are described in detail below.

However, the present disclosure is not limited to the exemplary embodiments included below, but may be implemented in various different forms. The exemplary embodiments are intended to complete the disclosure of the present disclosure and provided to fully inform the skilled in the art to which the disclosure pertains of the scope of the present disclosure. The present disclosure is defined only by the scope of the claims.

Furthermore, detailed descriptions related to well-known functions or configurations may be omitted in order not to unnecessarily obscure subject matter of the present disclosure.

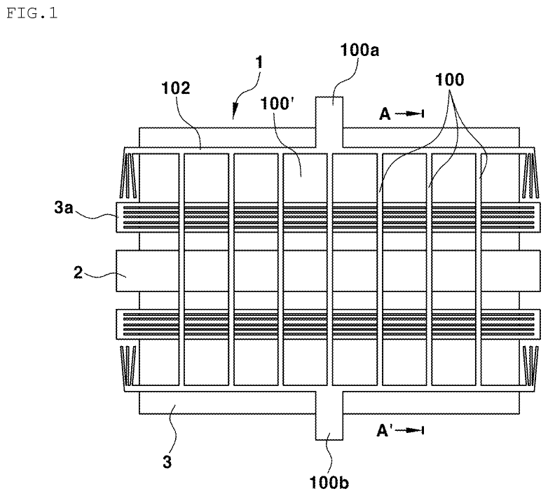

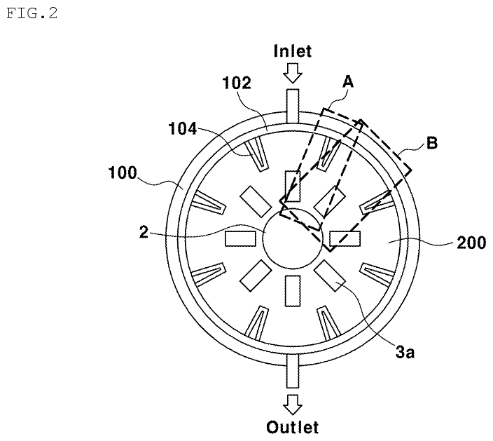

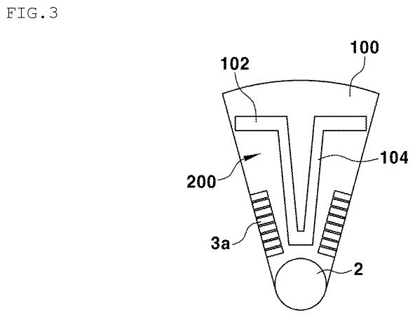

FIG. 1 is a view exemplarily illustrating a stator plate for a stator cooling device according to an exemplary embodiment of the present disclosure, FIG. 2 is a cross-sectional view taken along line A-A′ for showing a main flow path and a connection flow path for the stator cooling device according to an exemplary embodiment of the present disclosure, and FIG. 3 is an enlarged view exemplarily illustrating a region A in FIG. 2 for showing the connection flow path for the stator cooling device according to an exemplary embodiment of the present disclosure.

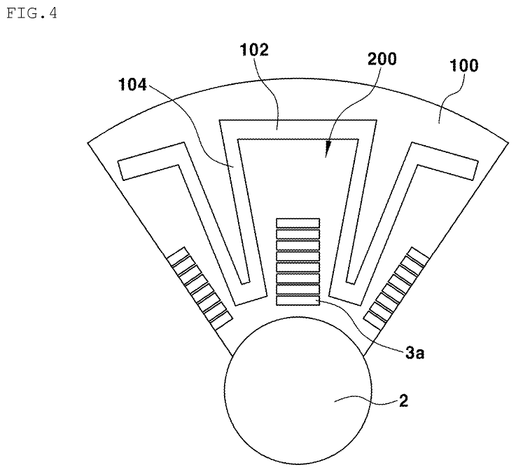

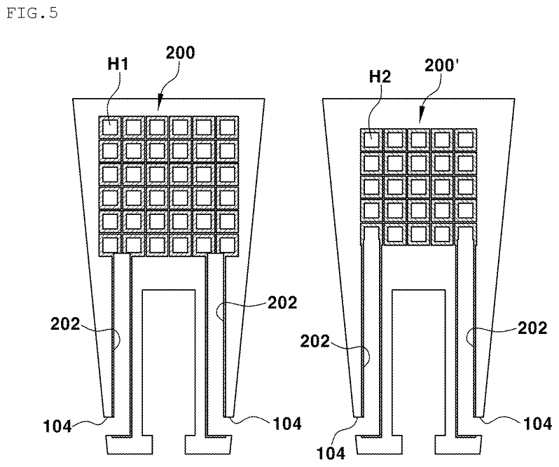

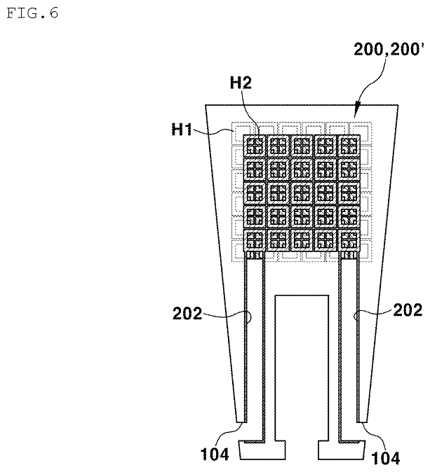

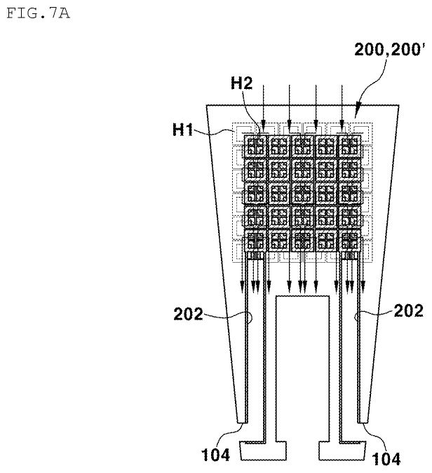

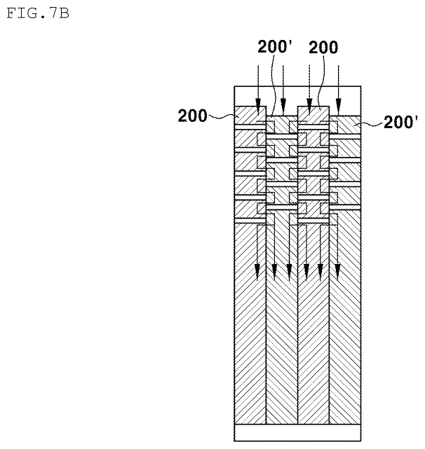

Furthermore, FIG. 4 is an enlarged view exemplarily illustrating a region B in FIG. 2 for showing a cooling flow path for the stator cooling device according to an exemplary embodiment of the present disclosure, FIG. 5 is a view exemplarily illustrating the cooling flow paths having different shapes for the stator cooling device according to an exemplary embodiment of the present disclosure, FIG. 6 is a view exemplarily illustrating a stacked state of the cooling flow path for the stator cooling device according to an exemplary embodiment of the present disclosure, and FIG. 7A and FIG. 7B are views exemplarily illustrating a fluid flow in the stacked state of the cooling flow path for the stator cooling device according to an exemplary embodiment of the present disclosure.

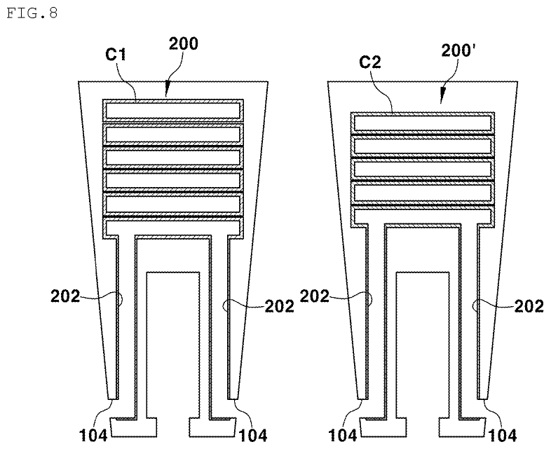

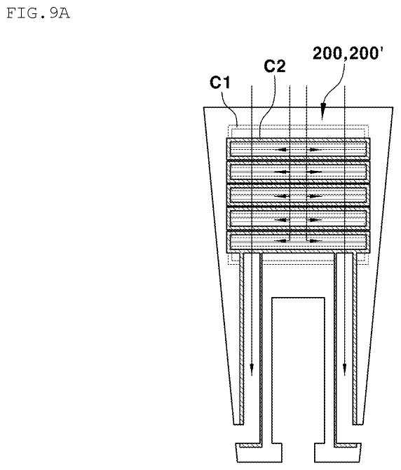

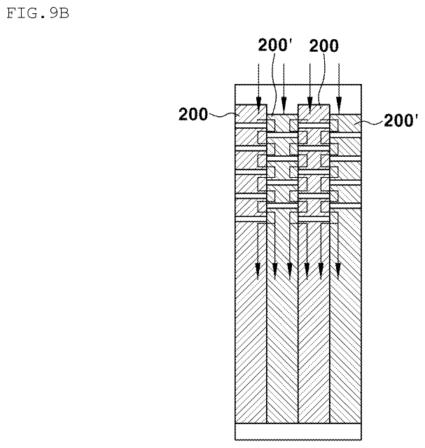

Furthermore, FIG. 8 is a view exemplarily illustrating another embodiment of the cooling flow paths for the stator cooling device according to an exemplary embodiment of the present disclosure, the cooling flow paths having different shapes, and FIG. 9A and FIG. 9B are views exemplarily illustrating another embodiment of a fluid flow in the stacked state of the cooling flow path for the stator cooling device according to an exemplary embodiment of the present disclosure.

Generally, a driving motor 1 used as a power source of a hybrid vehicle or an electric vehicle includes a rotor 2 having a cylindrical shape and includes a stator 3 which is disposed around the rotor 2 and on which a stator coil 3a is wound. In such a structure of the driving motor 1, since the stator coil 3a is a passage through which a current flows directly, a lot of heat is generated in the stator coil 3a. In some examples, the rotor 2 may include a plurality of permanent magnets. In some examples, the rotor 2 may include a plurality of electromagnets. The rotor 2 is configured for being rotated by an electromagnetic interaction with the stator 3.

Accordingly, in a situation in which a high-temperature state of the stator 3 including the stator coil 3a is maintained, a reduction in insulation performance, and in the long term, a reliability issue may occur. Therefore, it is important to effectively cool the stator coil 3a.

Accordingly, in an exemplary embodiment of the present disclosure, as illustrated in FIG. 1 and FIG. 2, a stator plate 100 may be included. The stator plate 100 is configured so that fluid supplied through an inlet 100a flows along a main flow path 102 and a plurality of connection flow paths 104 connected to the main flow path 102 and then the fluid is discharged through an outlet 100b, cooling the stator coil 3a.

Such a stator plate 100 may be positioned between a plurality of general stator plates 100′ along an axial direction of the stator 3 so that each stator plate 100 is spaced apart from each other with a predetermined distance.

That is, as illustrated in FIG. 1, the stator plate 100 which includes the main flow path 102 including the connection flow paths 104 and which includes a cooling flow path 200 so that the fluid is configured for passing therethrough may be disposed so that each stator plate 100 is spaced apart from each other by the predetermined distance and the stator plate 100 does not occupy a relatively large portion comparing to the general stator plates 100′ which are not disposed with a flow path particularly so that the fluid does not pass through the general stator plates 100′ and into which each stator coil 3a is inserted and disposed.

Therefore, through the present arrangement structure of the stator plate 100, a portion where magnetic flux density can pass through the general stator plates 100′ is maintained substantially, so that a reduction in electromagnetic performance may be minimized while the stator 3 is cooled.

The stator plate 100 is formed so that the plurality of stator coils 3a is inserted and disposed in the same manner as the general stator plates 100′. As illustrated in FIG. 3, the stator plate 100 is disposed with the plurality of connection flow paths 104 which extends toward the rotor 2, and is disposed with the main flow path 102 into which the fluid flows.

Here, in the connection flow paths 104, the connection flow paths 104 are connected to the main flow path 102 formed along a circumferential direction of the stator 3 (see FIG. 2). Here, it is preferable that the connection flow paths 104 extend so that each connection flow path 104 is positioned between the stator coils 3a adjacent to each other (see FIG. 3).

Each connection flow path 104 is formed in a “V” shape between the adjacent stator coils 3a and extends with a predetermined inclination (see FIG. 3). As the inclined structure is applied to the connection flow path 104, the flow of the fluid is facilitated. Therefore, the fluid supplied from the inlet 100a and passing through the main flow path 102 at an upper side may flow sequentially through the plurality of connection flow paths 104, and the fluid may flow to the main flow path 102 at a lower side and then may be discharged through the outlet 100b (see FIG. 2).

Meanwhile, as illustrated in FIG. 4, the stator plate 100 may include the cooling flow path 200 along with the main flow path 102 and the connection flow paths 104.

As illustrated in FIG. 7B, such cooling flow paths 200 and 200′ as a pair of cooling flow paths having different shapes may be stacked on the stator plate 100 along an axial direction of the rotor 2.

In other words, the cooling flow paths 200 and 200′ are connected to the main flow path 102 and extend toward the stator coil 3a, and includes a mesh structure for fluid flow. Here, the cooling flow paths 200 and 200′ as a consecutive pair of cooling flow paths having different shapes may be stacked.

As the pair of cooling flow paths 200 and 200′ including mesh holes H1 and H2 having different sizes is stacked in front and rear directions, the fluid continuously passes through in the mesh holes H1 and H2 that are overlapping with each other as illustrated in FIG. 6, and the fluid is guided to flow to the connection flow paths 104 disposed adjacent to the cooling flow paths 200 and 200'.

For example, as illustrated in FIG. 7A and FIG. 7B, when the fluid passing through the main flow path 102 is supplied to an upper portion of each of the cooling flow paths 200 and 200′ including the mesh holes H1 and H2 having different sizes, the fluid passing through the mesh hole H1 of the cooling flow path 200 flows to the mesh hole H2 of the cooling flow path 200′ which is stacked on the cooling flow path 200 in a staggered manner.

Here, the fluid in the cooling flow path 200′, which passes through the mesh hole H2, flows again in the mesh hole H1 of the cooling flow path 200 which is stacked in the staggered manner. As the flow of the fluid is repeated as described above, the fluid flows from the upper portion of the cooling flow paths 200 and 200′ to a lower portion of the cooling flow paths 200 and 200′, so that a time that the fluid remains on the stator plate 100 is configured for being secured, being configured for realizing cooling for the stator 3 directly.

At least two pair of cooling flow paths 200 and 200′ including the mesh holes H1 and H2 having different sizes may be continuously stacked on the stator plate 100 (see FIG. 7B). That is, at least four cooling flow paths 200 and 200′ may be continuously stacked on the stator plate 100. Furthermore, in a situation in which the cooling is further required, the pair of cooling flow paths 200 and 200′ including the mesh holes H1 and H2 having different sizes may be additionally stacked on the stator plate 100.

Furthermore, as illustrated in FIG. 5, the cooling flow path 200 includes a pair of outlets 202 to be connected to the connection flow paths 104 disposed adjacent to the outlets 202. As described above, the fluid passing through the mesh holes H1 and H2 flows through each outlet 202 to the adjacent connection flow paths 104.

Meanwhile, as another embodiment, the pair of cooling flow paths 200 and 200′ including flow channels C1 and C2 having different heights are stacked in the front and rear directions. Therefore, as illustrated in FIG. 8, since the fluid continuously passes through in the flow channels C1 and C2 that are overlapping with each other, and the fluid is guided to flow to the connection flow paths 104 disposed adjacent to the cooling flow paths 200 and 200'.

For example, as illustrated in FIG. 9A and FIG. 9B, when the fluid passing through the main flow path 102 is supplied to the upper portion of each of the cooling flow paths 200 and 200′ including the flow channels C1 and C2 having different heights, the fluid passing through the flow channel C1 of the cooling flow path 200 flows to the flow channel C2 of the cooling flow path 200′ which is stacked on the cooling flow path 200 in a staggered manner.

Here, the fluid in the cooling flow path 200′, which passes through the flow channel C2, flows again in the flow channel C1 of the cooling flow path 200 which is stacked in the staggered manner. As the flow of the fluid is repeated as described above, the fluid flows from the upper portion of the cooling flow paths 200 and 200′ to the lower portion of the cooling flow paths 200 and 200′, so that a time that the fluid remains on the stator plate 100 is configured for being secured, being configured for realizing cooling for the stator 3 directly.

Here, at least two pair of cooling flow paths 200 and 200′ including the flow channels C1 and C2 having different heights may be continuously stacked on the stator plate 100 (see FIG. 7B). That is, at least four cooling flow paths 200 and 200′ may be continuously stacked on the stator plate 100. Furthermore, in a situation in which the cooling is further required, the pair of cooling flow paths 200 and 200′ including the flow channels C1 and C2 having different heights may be additionally stacked on the stator plate 100.

Furthermore, as illustrated in FIG. 8, the cooling flow path 200 includes the pair of outlets 202 to be connected to the connection flow paths 104 disposed adjacent to the outlets 202. As described above, the fluid passing through the flow channels C1 and C2 flows through each outlet 202 to the adjacent connection flow paths 104.

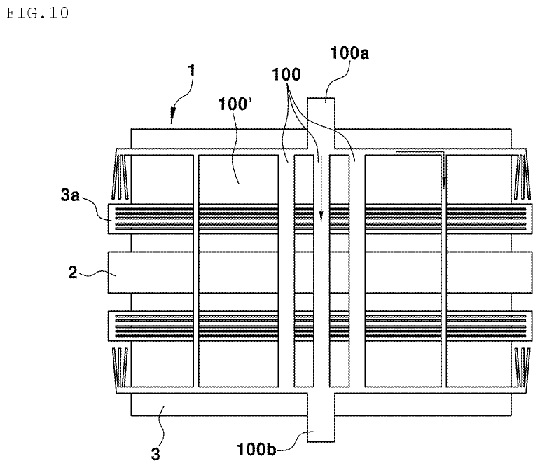

Hereinafter, FIG. 10 is a view exemplarily illustrating another embodiment for showing an arrangement of the stator plate for the stator cooling device according to an exemplary embodiment of the present disclosure.

As illustrated in FIG. 10, the stator plate 100 may be disposed so that a plurality of stator plates 100 is spaced along an axial direction of the rotor 2 and is disposed between the plurality of stacked stator plates 100′ with a predetermined distance so that the stator coil 3a is inserted into and disposed in the stator plates 100, and the cooling flow path 200 may be disposed so that the cooling flow path is concentrated on a center portion in the axial direction of the rotor 2.

That is, generally, the center portion along an axial direction of the driving motor 1 has the highest temperature due to heating, so that a problem caused by an ununiformity of an internal temperature of the driving motor 1 occurs.

To the present end, in an exemplary embodiment of the present disclosure, a cross-sectional area of the cooling flow path 200 is set relatively large so that the cooling flow path 200 is concentrated at the center portion. Accordingly, the concentrated cooling for the center portion is realized, being configured for solving the problem of the ununiformity of the internal temperature of the driving motor 1.

That is, as in the exemplary embodiment described above, in a situation in which the pair of cooling flow paths 200 and 200′ including the mesh holes H1 and H2 having different sizes is disposed or the pair of cooling flow paths 200 and 200′ including the flow channels C1 and C2 having different heights is disposed, the pair of stacked cooling flow paths 200 and 200′ is stacked continuously for the center portion of the driving motor 1, so that the cross-sectional area of the cooling flow path 200 may be set relatively large compared to the cross-sectional area of the cooling flow path 200 at a front side or a rear side of the driving motor 1 (see FIG. 7B and FIG. 9B).

Furthermore, in a situation in which the cross-sectional area of the cooling flow path 200 for the stator plate 100 at the center portion of the driving motor 1 is relatively large, a large amount of fluid is configured for being supplied to the cooling flow path 200 at the center portion by a pressure difference, and thus effective cooling of the center portion may be realized.

In an exemplary embodiment of the present disclosure, in the plurality of stator plates disposed so that the stator coils are inserted into and disposed in the stator plates, the plurality of stator plates in which the cooling flow path is applied is configured so that the cooling flow path including the mesh structure is applied and the shapes of each mesh structure continuously disposed has different shapes so that the fluid flows between the mesh structures, and thus there is an effect that effective cooling of the stator including the stator coil is configured for being realized.

Furthermore, in an exemplary embodiment of the present disclosure, the shape of the connection flow path connecting the cooling flow path has inclination so that the fluid smoothly flows, and thus there is an effect that supply and discharge of the supplied fluid are effectively performed.

Furthermore, in an exemplary embodiment of the present disclosure, as the center region along the axial direction of the motor includes the highest temperature due to heating generally, a relatively large number of stator plates in which the cooling flow path are applied is stacked on the center region, so that there is an effect that the uniformity of the internal temperature of the motor is configured for being increased.

While the present disclosure has been and described with reference to embodiment(s) illustrated in the drawings, the embodiment(s) are only illustrative, and it will be understood that various modifications can be made by those skilled in the art, and all or some of the described embodiment(s) may be optionally configured in combination. Accordingly, the true technical scope of the present disclosure should be defined by the technical spirit of the appended claims.

What is claimed is:

1. A stator cooling device comprising:
a stator plate comprising a plurality of stator coils, the stator plate being disposed with a main flow path comprising a connection flow path that extends toward an internal side of the state plate in a radius direction of the state plate; and
at least one pair of cooling flow paths stacked on the stator plate along an axial direction of the stator plate and having different structures,
wherein the at least one pair of cooling flow paths is configured to guide a fluid introduced through the main flow path to the connection flow path disposed adjacent to each of the cooling flow paths.

2. The stator cooling device of claim 1, wherein at least two cooling flow paths are continuously stacked on the stator plate.

3. The stator cooling device of claim 1, wherein the at least one pair of cooling flow paths is connected to the main flow path and extends toward the stator coils.

4. The stator cooling device of claim 3, wherein the at least one pair of cooling flow paths comprise mesh structures.

5. The stator cooling device of claim 4, wherein the at least one pair of cooling flow paths comprising mesh holes having different sizes is stacked in front and rear directions and the fluid continuously passes through in the mesh holes.

6. The stator cooling device of claim 5, wherein the at least one pair of cooling flow paths comprise a pair of outlets to be connected to the connection flow path disposed adjacent to the at least one pair of cooling flow paths, and the fluid passing through the mesh holes flows to the connection flow path through the pair of outlets.

7. The stator cooling device of claim 3, wherein the at least one pair of cooling flow paths comprise channel structures.

8. The stator cooling device of claim 7, wherein the at least one pair of cooling flow paths comprising flow channels having different heights is stacked in front and rear directions and the fluid continuously passes through in the flow channels.

9. The stator cooling device of claim 8, wherein the at least one pair of cooling flow paths comprise a pair of outlets to be connected to the connection flow path disposed adjacent to the at least one pair of cooling flow paths, and the fluid passing through the flow channels flows to the connection flow path through the pair of outlets.

10. The stator cooling device of claim 1, wherein the connection flow path extends so that the connection flow path is connected to the main flow path and is positioned between the stator coils that are positioned adjacent to each other
11. The stator cooling device of claim 10, wherein the connection flow path includes a “V” shape with an inclination.

12. The stator cooling device of claim 1, wherein the stator plate is disposed so that a plurality of stator plates is spaced apart from each other with a predetermined distance and is disposed between a plurality of general stator plates which is disposed along the axial direction of the stator plates and which is disposed so that the stator coils are inserted into and disposed in the general stator plates.

13. The stator cooling device of claim 1, wherein the stator plate is disposed so that a plurality of stator plates is spaced apart from each other with a predetermined distance and is disposed between a plurality of general stator plates disposed so that the stator coils are inserted into and disposed in the general stator plates, and the at least one pair of cooling flow paths are disposed so that the at least one pair of cooling flow paths are concentrated on a center portion in an axial direction of a rotor.

14. A stator cooling device comprising:
a stator; and
a rotor configured for being rotated with respect to the stator,
wherein the stator comprises:
a stator plate comprising a plurality of stator coils, the stator plate being disposed with a main flow path comprising a connection flow path that extends toward the rotor; and
at least one pair of cooling flow paths stacked on the stator plate along an axial direction of the stator and having different structures, and
wherein the at least one pair of cooling flow paths is configured to guide a fluid introduced through the main flow path to the connection flow path disposed adjacent to each of the cooling flow paths.

15. The stator cooling device of claim 14,
wherein the at least one pair of cooling flow paths are connected to the main flow path and extend between the stator coils, and
wherein the main flow path is connected to an inlet into which the fluid is supplied and an outlet from which the fluid is discharged.

16. The stator cooling device of claim 15, wherein the at least one pair of cooling flow paths comprise mesh structures so that the at least one pair of cooling flow paths comprising mesh holes having different sizes is stacked in front and rear directions and the fluid continuously passes through in the mesh holes.

17. The stator cooling device of claim 16, wherein the at least one pair of cooling flow paths comprise a pair of outlets to be connected to the connection flow path disposed adjacent to the at least one pair of cooling flow paths, and the fluid passing through the mesh holes flows to the connection flow path through the pair of outlets.

18. The stator cooling device of claim 15, wherein the at least one pair of cooling flow paths comprise channel structures so that the at least one pair of cooling flow paths including flow channels having different heights is stacked in front and rear directions and the fluid continuously passes through in the flow channels.

19. The stator cooling device of claim 18, wherein the at least one pair of cooling flow paths comprise a pair of outlets to be connected to the connection flow path disposed adjacent to the at least one pair of cooling flow paths, and the fluid passing through the flow channels flows to the connection flow path through the pair of outlets.

20. A vehicle comprising the stator cooling device of claim 14.
